(19) United States
(12) Patent Application Publication
(10) Pub. No.: US 2024/0139060 A1
(43) Pub. Date: May 2, 2024

(54) MASSAGE CHAIR, LIMB MASSAGER, AND LIMB MASSAGE MECHANISM

(71) Applicant: Gonghe Health Technology (Shanghai) Co., Ltd., Shanghai (CN)

(72) Inventor: Jiadong WU, Shanghai (CN)

(21) Appl. No.: 18/361,885

(22) Filed: Jul. 30, 2023

(30) Foreign Application Priority Data
Nov. 2, 2022 (CN) 202211362871.9

(51) Int. Cl. A61H 7/00; A61H 23/00

(52) U.S. Cl. CPC A61H 7/007; A61H 7/004; A61H 23/006; A61H 2201/0149; A61H 2201/149; A61H 2201/1676

(57) ABSTRACT

A limb massager mechanism includes a body, a first kneading device, and a second kneading device. The first kneading device comprises a first kneading component. The second kneading device comprises a second kneading component; a massage space for clamping a limb is formed between the first kneading component and the second kneading component. The limb massager mechanism comprises a percussion massage device. The percussion massage device is equipped with a percussion member capable of penetrating the second kneading component to perform percussive massage on the limb within the massage space.

### CROSS-REFERENCE TO RELATED DISCLOSURES

This disclosure claims priority to Chinese Patent Disclosure No. 202211362871.9 with a filing date of Nov. 2, 2022. The content of the aforementioned disclosure, including any intervening amendments thereto, is incorporated herein by reference.

### FIELD OF THE DISCLOSURE

The present disclosure relates to the field of massage equipment, and especially to a massager chair, a limb massager, and a limb massage mechanism.

### BACKGROUND OF THE DISCLOSURE

The massage chair is a commonly encountered massager. The existing massage chairs typically feature armrests equipped with airbag massage structures. These airbag massage structures include upper and lower airbags, which, through inflation and clamping, achieve a squeezing massage on the user's limbs. For a comprehensive understanding, reference may be made to Chinese Patent Disclosure No. CN202011302383.X. Enriching the design concepts of limb massage structures represents one of the optimization directions for massage chairs. In light of this, the present disclosure proposes the following.

### SUMMARY OF THE DISCLOSURE

The technical problem addressed by the present disclosure is to provide a solution for a massager with a massage structure different from prior art.

The solution as adopted by this disclosure is as follows. a limb massager mechanism, including a body, a first kneading device, and a second kneading device. The first kneading device includes a first kneading component; the second kneading device comprises a second kneading component. A massage space for clamping a limb is formed between the first kneading component and the second kneading component. The limb massager mechanism comprises a percussion massage device; the percussion massage device is equipped with a percussion member capable of penetrating the second kneading component to perform percussive massage on the limb within the massage space.

Preferably, the limb massage mechanism includes a first shaft configured for driving the first kneading component and the second kneading component to move towards or away from each other. The first shaft is configured to extend along a length direction of the limb within the massage space.

Preferably, the first shaft is positioned on one side of the limb, while the first kneading component is situated on the opposite side, along a width direction of the limb, relative to the first shaft.

Preferably, the first kneading device includes a first swinging arm coupled with the first kneading component. The first swinging arm is extended across the massage space to attach to the first shaft.

Preferably, the a first conversion component is attached to the first shaft. The first conversion component is configured to convert the rotational force of the first shaft into a swing motion of the first kneading component.

Preferably, the first conversion component includes a first eccentric member and a first swinging sleeve; the first eccentric member is mounted on and rotates with the first shaft. The first swinging sleeve is fitted over the first eccentric member and connected to the first swinging arm. A swinging axis of the first swinging sleeve coincides with a rotational axis of the first eccentric member. The first swinging sleeve is secured to the body via a first guiding restriction member, limiting rotation of the first swinging sleeve independent of the first eccentric member.

Preferably, in the width direction of the limb, the second kneading portion and the first shaft are positioned on the same side.

Preferably, a second conversion component is provided on the first shaft; the second conversion component is configured to convert the rational force of the first shaft into a swinging motion of the second kneading component.

Preferably, the second kneading device comprises a second swinging arm coupled with the second kneading component. The second conversion component comprises a second eccentric member and a second swinging sleeve. The second swinging sleeve is fitted over the first shaft and is rotated with the first shaft. The second swinging sleeve is fitted over the second eccentric member and connected to the second swinging arm. A swinging axis of the second swinging sleeve coincides with a rotational axis of the second eccentric member; the second swinging sleeve is secured to the body via a second guiding restriction member, limiting rotation of the second swinging sleeve independent of the second eccentric member.

Preferably, the percussion massage device includes a percussion shaft, and an eccentric component fitted over the percussion shaft and rotated with the percussion shaft; the swinging sleeve is fitted over the eccentric component. A swinging axis of the swing sleeve coincides with a rotational axis of the eccentric component. The percussion member is secured to the swinging sleeve so that the percussion member is driven by the eccentric component and perform percussive massage.

Preferably, the second kneading device includes a third guiding restriction member that allows radial movement of the percussion member along the percussion shaft and restricts the rotation of the percussion member with the percussion shaft.

Preferably, the percussion massage device is fixedly connected to the second kneading device.

Preferably, the third guiding restriction member is fixedly connected to the body.

Preferably, the limb massage mechanism further comprises a second shaft configured for driving the second kneading component and the first kneading component to move towards or away from each other. The second shaft is arranged parallelly to the first shaft.

Preferably, the second shaft is coupled with a second conversion component; the second conversion component is configured for converting the rotational force of the second shaft into a swinging motion of the second kneading portion.

Preferably, the second kneading device comprises a second swinging arm attached to the second kneading component. The second conversion component comprises a second eccentric member and a second swinging sleeve. The second eccentric member is fitted over the second shaft and rotates with the second shaft. The second swinging sleeve is fitted over the second eccentric member. A swinging axis of the second swinging sleeve coincides with a rotational axis of the second eccentric member. The second swinging sleeve is connected to the body through the second guiding restriction member, limiting the rotation of the second swinging sleeve independent of the second eccentric member.

Preferably, the first swinging arm is provided with a first massage airbag configured for squeezing and massaging the limb.

Preferably, the second kneading component is provided with a second massage airbag configured for squeezing and massaging the limb.

The present disclosure further provides a limb massager having both kneading and percussion massage. The limb massager includes the aforementioned limb massage mechanism

The present disclosure further provides a massage chair equipped with armrests. The armrest is provided with the aforementioned limb massage mechanism.

By employing the aforementioned technical solutions, the present disclosure offers the following advantages:
1. The limb massager provided in this disclosure enables kneading and rubbing massage of the limbs by the first kneading component and the second kneading component, while the percussion member of the percussion massage device can penetrate the second kneading component into the massage space to deliver percussive massage to the limbs.
2. When the first kneading component and the second kneading component are equipped with massage airbags or molded sponges, these members can assist in gripping the user's limbs and cushion the impact of the massage forces on the limbs.

### BRIEF DESCRIPTION OF THE DRAWINGS

In order to provide a clearer understanding of the technical solutions of the embodiments of the present disclosure, the accompanying drawings will be briefly described. It should be understood that the following description of the drawings is merely exemplary and does not limit the scope of the present disclosure.

FIGS. 1 to 3 show schematic diagrams of the limb massager in the first embodiment from different perspectives.

FIG. 4 shows a first exploded view of the limb massager in the first embodiment.

FIG. 5 shows a second exploded view of the limb massager in the first embodiment.

FIG. 6 shows a schematic diagram of the first kneading component, second kneading component, first conversion component, second conversion component, first guiding restriction member, and second guiding restriction member in the first embodiment of the limb massager.

FIG. 7 shows the corresponding exploded view of FIG. 6.

FIG. 8 shows a schematic diagram of the second kneading component.

FIG. 9 shows an exploded view of the second kneading component.

FIG. 10 shows a schematic diagram of the limb massager in the second embodiment.

FIG. 11 shows the first exploded view of the limb massager in the second embodiment.

FIG. 12 shows the second exploded view of the limb massager in the second embodiment.

FIG. 13 shows a schematic diagram of the percussion massage device in the second embodiment.

FIGS. 14 and 15 respectively show schematic diagrams of the limb massager in the third embodiment from different perspectives.

FIG. 16 shows a limb massage mechanism according to the four embodiment of the present disclosure.

### CHARACTER REFERENCES

Body 1, First kneading component 2, First massage frame 2A, First massage airbag 2B, Second kneading component 3, Second massage frame 3A, Second massage airbag 3B, Percussion massage device M, Massage drive mechanism 4, Motor 5, First shaft 6, Second shaft 7, first conversion component 8, Second conversion component 9, First guiding restriction member 10, Second guiding restriction member 11, Connecting base 12.

### DETAILED DESCRIPTION OF THE DISCLOSURE

In order to further clarify the objectives, technical solutions, and advantages of the embodiments of the present disclosure, detailed descriptions will be provided with reference to the accompanying drawings. It should be understood that the components shown in the drawings, as described herein, can be arranged and designed in various configurations. Based on the embodiments described in the present disclosure, all other embodiments that are obtained by those skilled in the art without exercising inventive labor are within the scope of protection of the present disclosure.

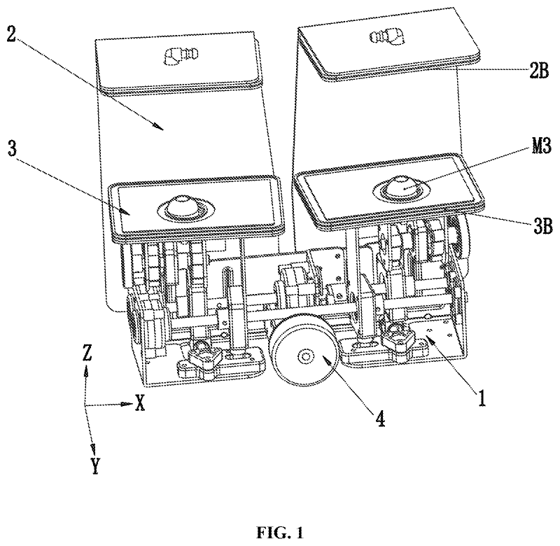

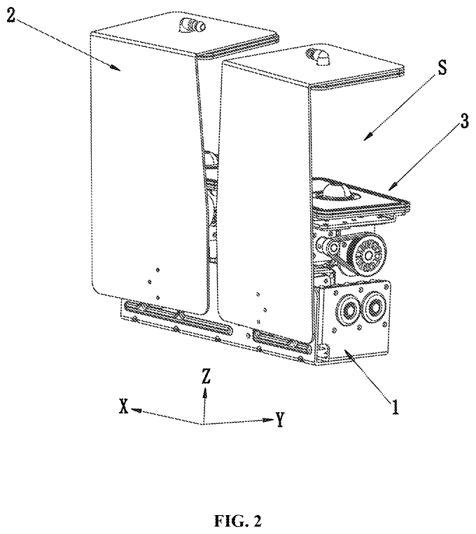

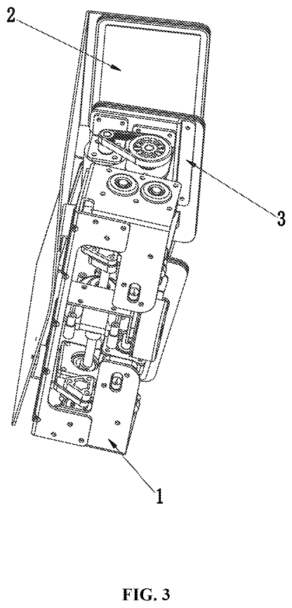

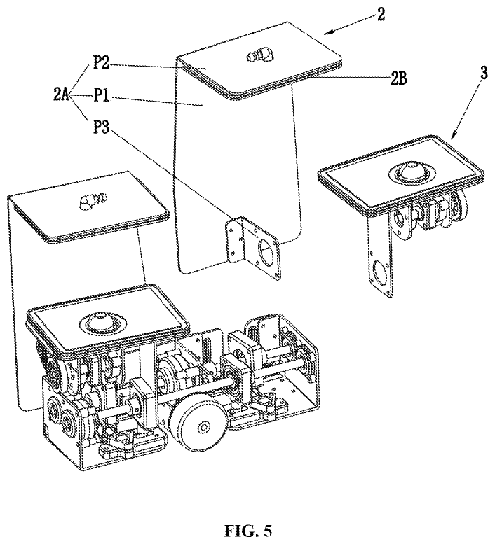

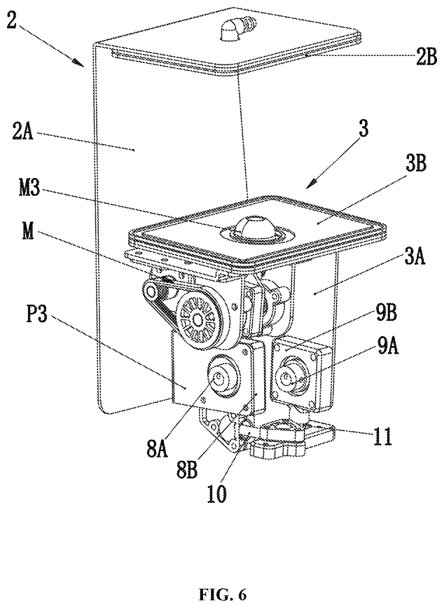

The following detailed description of certain embodiments of the present disclosure will be provided in conjunction with the accompanying drawings. Unless otherwise stated, the features in the following embodiments can be combined with each other as long as there is no conflict.

[First Embodiment] Referring to FIGS. 1 to 9, in one embodiment, the limb massager of the present disclosure includes a body 1, a first kneading device 2, a second kneading device 3, and a massage drive mechanism 4. The first kneading device 2 and the second kneading device 3 form a massage space for gripping the limb. The limb massager is suitable for gripping a limb such as an arm, leg, foot, or shoulder. The first kneading device 2 is configured to massage one side of the limb (e.g., the upper side of the arm, leg, foot, or shoulder), while the second kneading device 3 is configured to massage the other side of the limb (e.g., the lower side of the arm, leg, foot, or shoulder). The massage drive mechanism 4 is installed on the body 1 and is responsible for driving the first kneading device 2 and the second kneading device 3 to move closer or farther apart, generating the massage action. In this embodiment, two sets of the first kneading device 2 and the second kneading device 3 are provided. The two sets of the first kneading device 2 and the second kneading device 3 are spaced along a predetermined direction (in this embodiment, the left-right direction). However, the number of sets is not limited to this and can be adjusted according to the design requirements. The body 1 can be installed on the armrest of a massage chair, allowing the massager to massage the user's arms. It should be understood that the limb massager of the present disclosure can also be designed as a standalone device, specifically for massaging specific limb positions such as arms, legs, feet, or shoulders. Further details will be discussed below for clarity. For convenience, the X-direction in the drawings represents the left-right direction (corresponding to a length direction of limbs such as arms), the Y-direction represents the front-back direction, and the Z-direction represents the bottom-up direction (corresponding to a width direction of limbs such as arms). Multiple sets of first kneading components 2 and second kneading components 3 distributed along the predetermined direction can massage different positions of the user's limb (e.g., one set for massaging the wrist area and another set for massaging the elbow joint area).

[Body] The body 1 has left and right side walls, a front wall, and a bottom wall, each of which is thin and plate-like in shape.

[First Kneading Device] The first kneading device 2 includes a first massage frame 2A and a first massage airbag 2B. In this embodiment, the first massage airbag 2B serves as the first massage structure for the upper side of the limb. The first massage frame 2A includes a first swing arm P1 extending up and down and a first kneading portion P2 extending back and front. The lower side of the first swing arm P1 is fixedly connected to the first conversion component 8 via a connecting part P3, while the upper side of the first swing arm P1 is connected to the first kneading portion P2. The first massage airbag 2B, as part of the first massage structure, is mounted on the first kneading portion P2. The first massage airbag 2B is capable of squeezing and therefore providing massage for limbs. It should be understood that, in another embodiment, the first massage structure may not only include the first massage airbag 2B. In this embodiment, both the first swing arm P1 and the first kneading portion P2 are thin and plate-like in shape. The first massage airbag 2B can be replaced with a molded sponge.

[Second Kneading Device] The second kneading device 3 includes a second massage frame 3A and a second massage airbag 3B. The second massage airbag 3B is mounted on the second massage frame 3A and serves as the second massage structure for the lower side of the limb. As shown in FIG. 2, the first massage structure and the second massage structure are arranged in opposing directions with a space S for gripping the user's limb in between. In this embodiment, the second massage frame 3A includes a second swing arm Q1 extending up and down and a second kneading portion Q2 extending left and right. The lower side of the second swing arm Q1 is fixedly connected to the second conversion component 9, while the upper side of the second swing arm Q1 is connected to the second kneading portion Q2. The second massage structure is mounted on the second kneading portion Q2, which is located below the first kneading portion P2. The massage space S is formed between the second kneading portion Q2 and the first kneading portion P2. In this embodiment, both the second swing arm Q1 and the second kneading portion Q2 are thin and plate-like in shape. The inflation of the first massage airbag 2B and the second massage airbag 3B enables them to grip the user's limb and cushion the massage force from the first and second massage frames. The second massage airbag 3B can be replaced with a molded sponge.

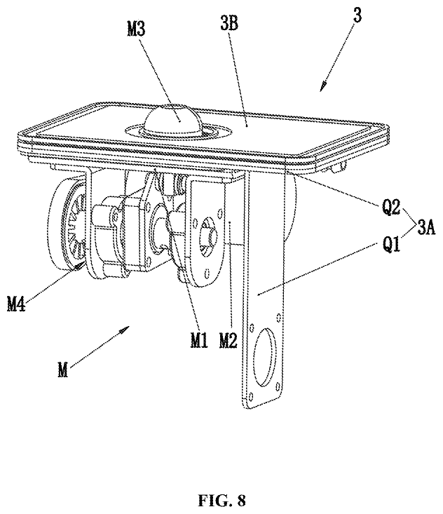

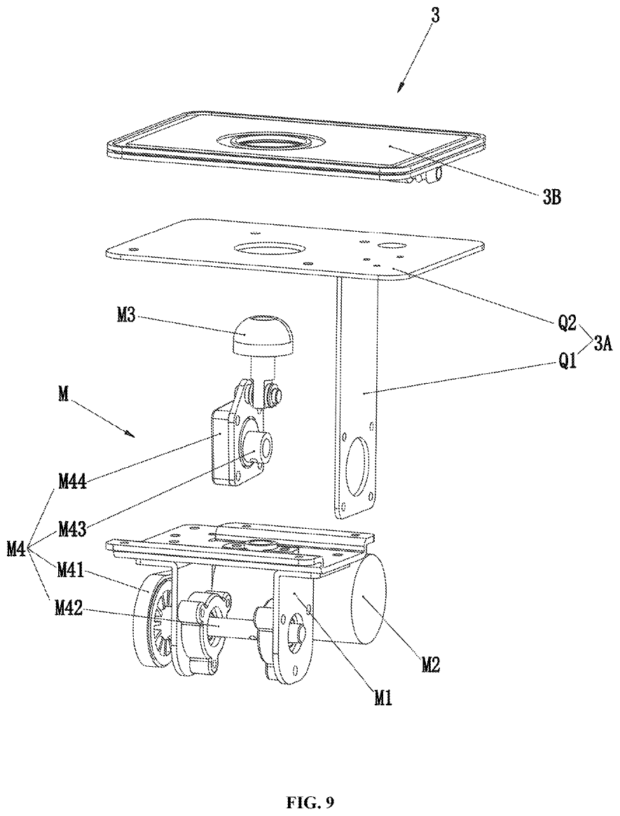

In this embodiment, the percussion massage device M is mounted on the second kneading device 3 and can swing along with it. Referring to FIGS. 8 and 9, the percussion massage device M includes a support frame M1, a percussion motor M2, a percussion member M3, and a percussion drive assembly M4. The support frame M1 is fixed to the second kneading portion Q2 of the second massage frame 3A. The percussion motor M2 is mounted on the support frame M1 and drives the percussion member M3 to move up and down through the percussion drive assembly M4, achieving the percussion action. The percussion drive assembly M4 includes a belt drive structure M41, a percussion shaft M42, an eccentric member M43, and a swinging sleeve M44. The percussion motor M2 drives the percussion shaft M42, which is mounted on the support frame M1, to rotate through the belt drive structure M41. The eccentric member M43 is fitted over the percussion shaft M42 and rotates with it. The swinging sleeve M44 is fitted over the eccentric member M43, and its swinging axis coincides with the rotation axis of the eccentric member M43. Bearings can be provided between the swinging sleeve M44 and the eccentric member M43. The percussion member M3 is limited to move in the vertical direction relative to the second massage frame 3A (i.e., the up and down direction corresponds to the diameter direction of the percussion shaft M42). The second massage airbag 3B and the second kneading portion Q2 have through-holes for the percussion member M3 to pass through. The percussion member M3 is fixedly connected to the swinging sleeve M44. When the percussion motor M2 operates, it drives the percussion shaft M42 and the eccentric member M43 to rotate, causing the swinging sleeve M44 to swing. As a result, the percussion member M3 moves up and down relative to the second kneading portion Q2, passing through the through-holes of the second massage airbag 3B and the second kneading portion Q2 (i.e., through the second kneading device 3) and entering the massage space to perform percussive massage on the limb. The percussion massage device M can perform percussive massage on the lower side of the limb.

[Massage Drive Mechanism] The massage drive mechanism 4 includes a motor 5, a first shaft 6, a second shaft 7, a first conversion component 8, a second conversion component 9, a first guiding restriction member 10, a second guiding restriction member 11, and a connecting base 12.

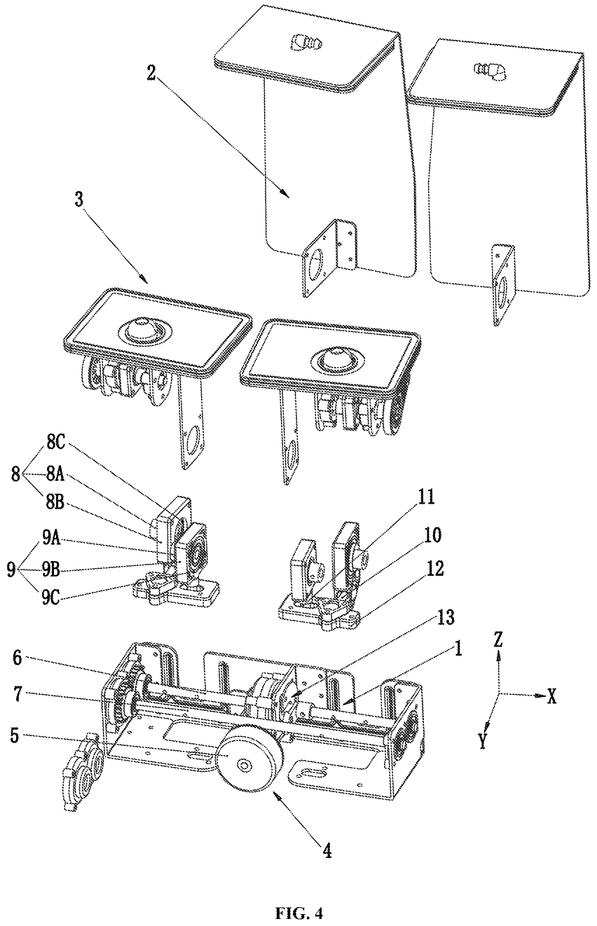

Referring to FIG. 4, the first shaft 6 and the second shaft 7 are parallel to each other. In this embodiment, both shafts extend in the left-right direction, and both extends along the length direction of the clamped limbs. The second shaft 7 is located behind the first shaft 6. Both the first shaft 6 and the second shaft 7 are driven and rotated by the motor 5. Specifically, in this embodiment, there is a gear transmission between the first shaft 6 and the second shaft 7. The motor 5 is connected to the first shaft 6, and when the motor 5 drives the first shaft 6 to rotate, the first shaft 6 drives the second shaft 7 to rotate through the gear transmission. In another embodiment, the motor 5 can be changed to be connected to the second shaft 7. In another embodiment, the first shaft 6 can be connected to the motor 5 via a first transmission, and the second shaft 7 can be connected to the motor 5 via a second transmission. In this case, the motor 5 can be a dual-output shaft motor, and the first and second transmissions may include commonly used transmissions such as worm drives, gear transmissions, or belt drives, without further elaboration. In another embodiment, two motors 5 can be set to drive the first shaft 6 and the second shaft 7 to rotate, respectively.

The first shaft 6 is configured to drive the first kneading portion P2 towards or away from second kneading portion Q2. The first shaft 6 is located one side corresponding to the clamped limb (i.e., the lower side of the massage space S). The first kneading portion P2 is configured on a width direction of the limb opposite to the first shaft 6. In the width direction of the limb, the second kneading portion Q2 and the first shaft 6 is placed on the same side. The first swing arm Q1 is coupled on the first kneading portion P2, and the first swing arm Q1 is coupled to the first shaft 6 across the massage space S.

The first conversion component 8 is connected to the first shaft 6. The first conversion component 8 is capable of converting the rotational force of the first shaft into a swing motion of the first kneading portion P2. The first conversion component 8 is connected to the first shaft 6 and the first kneading device 2, and is capable fo covering the rotation force of the first shaft 6 into the swing motion of the first kneading portion P2. Specifically, the first conversion component 8 is connected to the first shaft 6 to the first kneading device 2, particularly the first massage frame 2A, and is configured to transform the rotational motion of the first shaft 6 into a swing motion of the first massage frame 2A. In this embodiment, the first conversion component 8 includes a first eccentric member 8A, a first swinging sleeve 8B, and a first bearing member 8C. The first eccentric member 8A is fitted over the first shaft 6 and rotates with it. The first swinging sleeve 8B is fitted over the first eccentric member 8A, and the swinging axis of the first swinging sleeve 8B coincides with the rotational axis of the first eccentric member 8A. The first swinging sleeve 8B is connected to the body 1 through the first guiding restriction member 10, which restricts its movement and prevents it from rotating with the first eccentric member 8A. The first bearing member 8C is located between the first eccentric member 8A and the first swinging sleeve 8B. In this embodiment, the first end of the first guiding restriction member 10 is ball-jointed to the first swinging sleeve 8B, and the second end is ball-jointed to the body 1. The connecting base 12 is fixed to the bottom wall of the body 1, and the second end of the first guiding restriction member 10 indirectly ball-joints to the body 1 through ball joint connection with the connecting base 12. However, it should be understood that, in another embodiment, the second end of the first guiding restriction member 10 can also be directly ball-jointed to the body 1.

The second shaft 7 is configured to drive the second kneading portion Q2 towards or away from the first kneading portion P2. The second shaft 7 is coupled with the second conversation component 9. The second conversation component 9 is configured to convert the rotational force of the second shaft 7 into the swing motion of the second kneading portion Q2. The second conversion component 9 is connected to the second shaft 7 and the second kneading device 3, and is capable of converting the rotational force of the second shaft 7 into a swing motion of the second kneading portion Q2. Specifically, the second conversion component 9 is connected to the second shaft 7 to the second massage frame 3A, and is configured to transform the rotational motion of the second shaft 7 into a swing motion of the second massage frame 3A. In this embodiment, the second conversion component 9 includes a second eccentric member 9A, a second swinging sleeve 9B, and a second bearing member 9C. The second eccentric member 9A is fitted over the second shaft 7 and rotates with it. The second swinging sleeve 9B is fitted over the second eccentric member 9A, and the swinging axis of the second swinging sleeve 9B coincides with the rotational axis of the second eccentric member 9A. The second swinging sleeve 9B is connected to the body 1 through the second guiding restriction member 11, which restricts its movement and prevents it from rotating with the second eccentric member 9A. The second bearing member 9C is located between the second eccentric member 9A and the second swinging sleeve 9B. In this embodiment, the first end of the second guiding restriction member 11 is fixed to the second swinging sleeve 9B, and the second end of the second guiding restriction member 11 is slidably connected to the body 1. The second end of the second guiding restriction member 11 indirectly slides on the body 1 through sliding connection with the connecting base 12. However, it should be understood that, in another embodiment, the second end of the second guiding restriction member 11 may be directly slidably connected to the body 1.

The second end of the first restriction member, the second end of the second restriction member are connected to the body through one connecting base 12 so that the whole limb massager can be compact.

In this embodiment, the massager further includes a position sensor 13, which in this embodiment is a Hall sensor configured to detect the rotational speed of the first shaft 6. The position sensor 13 may be replaced with an optocoupler sensor. By detecting the rotational speed of the first shaft 6 using a Hall sensor or optocoupler sensor, the swinging frequency of the first massage frame and the second massage frame can be indirectly determined. The control mechanism of the massager can detect through the position sensor 13. When users trigger the massager to stop work (the massager is provided with a control switch which is not shown in the figures), and move the first massage frame and the second massage frame to initial positions, thereby facilitating users to place their limbs into the massage space in their second use, and keeps the appearance the same to its off state.

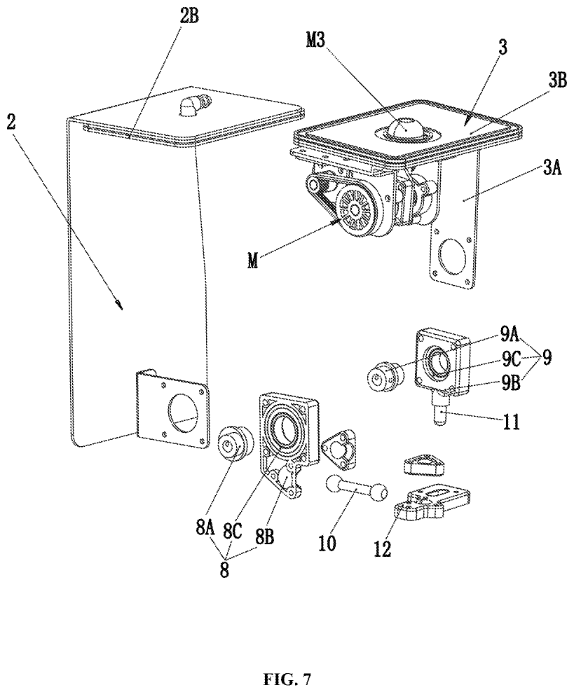

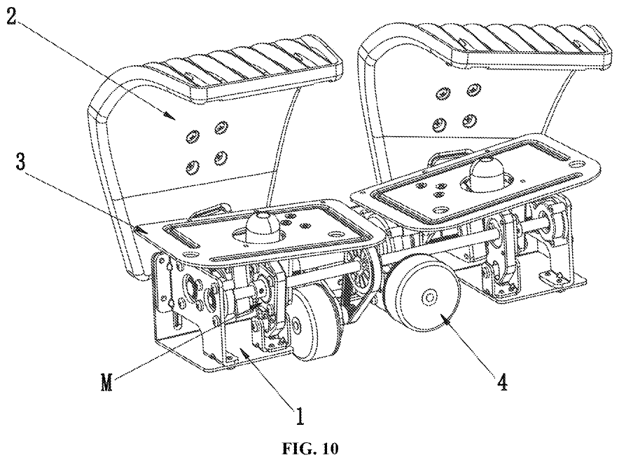

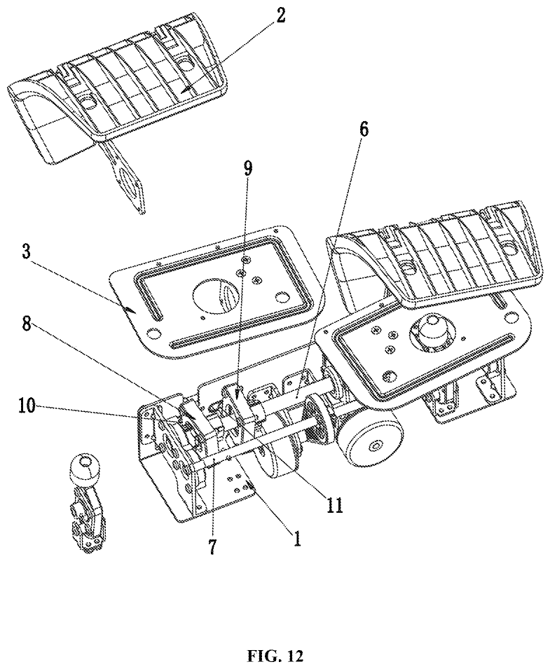

The above describes the first embodiment of the limb massager according to the present disclosure. Referring to FIG. 7, in the aforementioned embodiment, the first eccentric member 8A and the second eccentric member 9A are inclined eccentric structures guided by the first guiding restriction member and the second guiding restriction member. However, it should be understood that the embodiments of the first conversion component and the second conversion component are not limited to this configuration. In another embodiment, the first eccentric member 8A and the second eccentric member 9A can be a direct eccentric structure, and the corresponding guiding method of the first guiding restriction member and the second guiding restriction member can be adjusted accordingly. The use of a direct eccentric structure to achieve component swinging is disclosed in other patent applications, such as Chinese Patent Application No. 201922195514.8 (wherein the deflection block of CN201922195514.8 represents a direct eccentric structure), and further description is omitted. It should also be noted that in the aforementioned embodiment, the first and second shafts are connected to the corresponding first and second eccentric members in a separate structure, but they can also be designed as an integral molded structure.

[Second Embodiment] In the first embodiment, the first shaft 6 drives the swing motion of the first kneading device 2 through the first conversion component 8, and the second shaft 7 drives the swing motion of the second kneading device 3 through the second conversion component 9. However, it should be understood that the first kneading device 2 and the second kneading device 3 may be driven to swing by the same shaft support. Specifically, referring to FIGS. 10 to 13, the limb massager of the second embodiment includes a body 1, a first kneading device 2, a second kneading device 3, and a massage drive mechanism 4. The massage drive mechanism 4 is configured to drive the first kneading device 2 and the second kneading device 3 to move towards or away from each other to generate massage actions. The massage drive mechanism 4 includes a first conversion component 8, a second conversion component 9, a first guiding restriction member 10, and a second guiding restriction member 11. The first conversion component 8 is connected to the first shaft 6 and the first kneading device 2, and is capable of converting the rotational force of the first shaft 6 into the swing motion of the first kneading portion P2 of the first kneading device 2. The second conversion component 9 is connected to the first shaft 6 and the second kneading device 3, and is capable of converting the rotational force of the first shaft 6 into the swing motion of the second kneading portion Q2 of the second kneading device 3. The massage drive mechanism 4 is configured to perform kneading massage on the limb inserted by utilizing the swing motion of the first kneading device 2 and the second kneading device 3. In the figures showing the second embodiment, the massager is depicted, omitting the massage airbags on the first kneading device 2 and the second kneading device 3 (the massage airbags can be replaced with molded sponges) and only shows the corresponding massage frames.

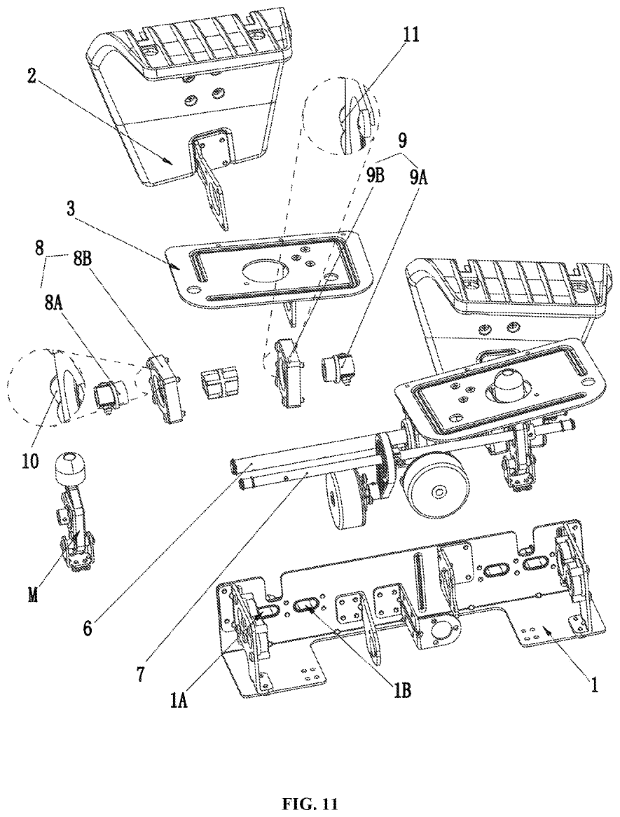

The first conversion component 8 includes a first eccentric member 8A and a first swinging sleeve 8B. The first eccentric member 8A is fitted over the first shaft 6 and rotates with it. The first swinging sleeve 8B is fitted over the first eccentric member 8A, and the swinging axis of the first swinging sleeve 8B coincides with the rotational axis of the first eccentric member 8A. The first swinging sleeve 8B is connected to the body 1 through the first guiding restriction member 10, which restricts its movement and prevents it from rotating with the first eccentric member 8A. In the second embodiment, one end of the first guiding restriction member 10 is fixed to the first swinging sleeve 8B, and the other end is slidingly engaged with the body 1 (as shown in FIG. 11, the body 1 has a first sliding groove 1A that cooperates with the first guiding restriction member 10).

The second conversion component 9 includes a second eccentric member 9A and a second swinging sleeve 9B. The second eccentric member 9A is fitted over the second shaft 7 and rotates with it. The second swinging sleeve 9B is fitted over the second eccentric member 9A, and the swinging axis of the second swinging sleeve 9B coincides with the rotational axis of the second eccentric member 9A. The second swinging sleeve 9B is connected to the body 1 through the second guiding restriction member 11, which restricts its movement and prevents it from rotating with the first eccentric member 8A. In the second embodiment, one end of the second guiding restriction member 11 is fixed to the second swinging sleeve 9B, and the other end is slidingly engaged with the body 1 (as shown in FIG. 11, the body 1 has a second sliding groove 1B that cooperates with the second guiding restriction member 11).

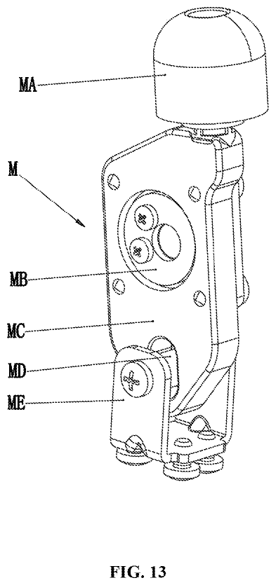

The second embodiment of the limb massager also includes a percussion massage device M. Referring to FIG. 13, the percussion massage device M includes a percussion member MA, an eccentric wheel MB, a swinging sleeve MC, a limiting rod MD, and a connecting base ME. The percussion member MA is configured to move up and down relative to the second kneading device 3. The eccentric wheel MB, swinging sleeve MC, limiting rod MD, and connecting base ME form a percussion drive assembly, which converts the rotational motion of the second shaft 7 into the up and down motion of the percussion member MA. The eccentric wheel MB is fixed over the second shaft 7, and the swinging sleeve MC is fitted over the eccentric wheel MB. The percussion member MA is mounted on the swinging sleeve MC. The limiting rod MD is fixed to the body 1 through the connecting base ME, and the limiting rod MD and the swinging sleeve MC slide against each other to allow the swinging sleeve MC to move up and down within a set range. When the second shaft 7 is rotated, the eccentric wheel MB pushes the swinging sleeve MC and the percussion member MA to move up and down. The limiting rod MD is defined as a third guiding restriction member, and cooperates with the swing sleeve to allow the percussion member MA to rotate with the second shaft 7 (i.e., percussion shaft). As the percussion member MA moves up and down, it passes through the second kneading device 3 and enters the massage space to perform percussive massage on the limbs.

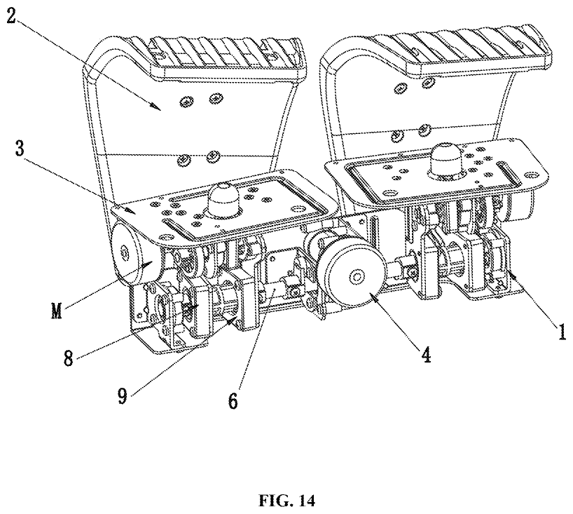

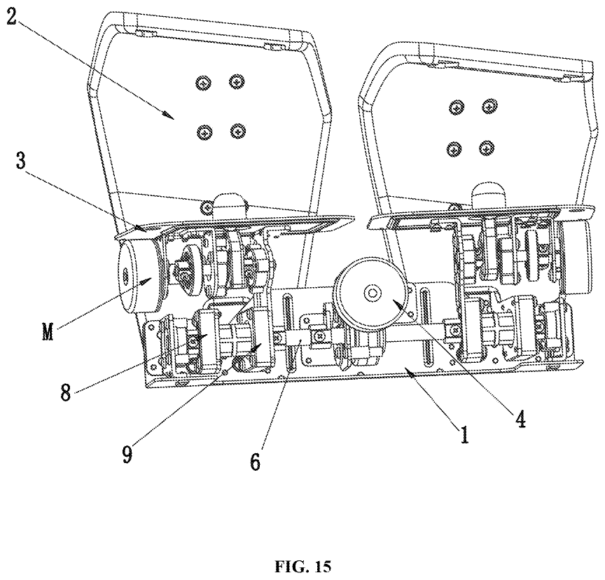

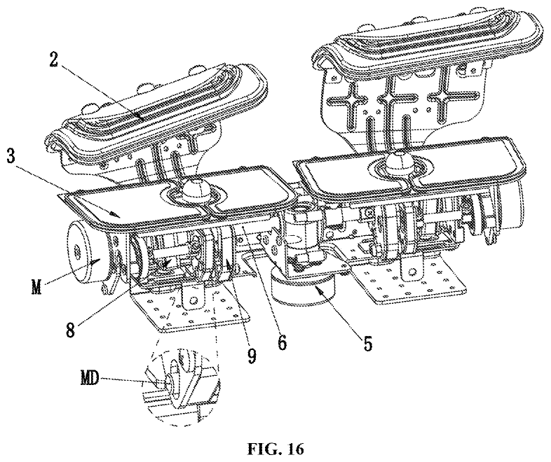

In the second embodiment, other unmentioned features can be referred to the first embodiment of the present disclosure. For example, the second embodiment may include the aforementioned first bearing member 8C and second bearing member 9C.

[THIRD EMBODIMENT] Based on the second embodiment, the configuration of the limb massager can be modified by incorporating the design concept from the first embodiment. Specifically, as shown in FIGS. 14 and 15, the limb massager in the third embodiment includes a body 1, a first kneading device 2, a second kneading device 3, and a massage drive mechanism 4. The first and second kneading components 2 and 3 are driven by a first shaft 6 to perform swing motions, which are similar to the structure in the second embodiment and thus will not be repeated. However, in contrast to the second embodiment, in the third embodiment, a percussion massage device M is placed on the second kneading device 3. The specific structure of the percussion massage device M may be the same as described in the first embodiment.

[FOURTH EMBODIMENT] Referring to FIG. 16, the design concept of the fourth embodiment is consistent with the third embodiment. Both the first kneading device 2 and the second kneading device 3 are driven and oscillate by the first shaft 6, while the percussion massage device M is positioned on the second kneading device 3. Unlike the third embodiment, the percussion massage device M in the fourth embodiment adopts the same design concept as the percussion massage device in the second embodiment. The solution involves the coordination between the limiting rod MD and the swinging sleeve to allow the radial movement of the percussion component along the percussion shaft and restrict its rotation with the percussion shaft. In the fourth embodiment, the percussion shaft is rotatably connected to the second swinging sleeve of the second conversion component 9, and the limiting rod MD is fixedly attached to the second swinging sleeve of the second conversion component 9, resulting in a more compact overall structure.

Additionally, this disclosure also provides a massage chair that includes armrests located on both sides. Either of the armrests is equipped with the aforementioned limb massagers, providing a comprehensive massage experience for the user.

The foregoing discussion represents only specific embodiments of the present disclosure, but the scope of protection of the present disclosure is not limited thereto. Any skilled person familiar with the relevant technical field, within the technological scope disclosed by the present disclosure, should consider any readily conceivable variations or substitutions, which should be encompassed within the scope of protection of the present disclosure. Therefore, the scope of protection of the present disclosure should be determined by the claims.

What is claimed is:

1. A limb massager mechanism, comprising a body, a first kneading device, and a second kneading device; the first kneading device comprises a first kneading component; the second kneading device comprises a second kneading component; a massage space for clamping a limb is formed between the first kneading component and the second kneading component;
wherein the limb massager mechanism comprises a percussion massage device; the percussion massage device is equipped with a percussion member capable of penetrating the second kneading component to perform percussive massage on the limb within the massage space.

2. The limb massage mechanism according to claim 1, wherein the limb massage mechanism comprises a first shaft configured for driving the first kneading component and the second kneading component to move towards or away from each other; the first shaft is configured to extend along a length direction of the limb within the massage space.

3. The limb massage mechanism according to claim 2, the first shaft is positioned on one side of the limb, while the first kneading component is situated on the opposite side, along a width direction of the limb, relative to the first shaft.

4. The limb massage mechanism according to claim 3, wherein the first kneading device comprises a first swinging arm coupled with the first kneading component; the first swinging arm is extended across the massage space to attach to the first shaft.

5. The limb massage mechanism according to claim 4, wherein the a first conversion component is attached to the first shaft; the first conversion component is configured to convert the rotational force of the first shaft into a swing motion of the first kneading component.

6. The limb massage mechanism according to claim 5, wherein the first conversion component comprises a first eccentric member and a first swinging sleeve; the first eccentric member is mounted on and rotates with the first shaft; the first swinging sleeve is fitted over the first eccentric member and connected to the first swinging arm; a swinging axis of the first swinging sleeve coincides with a rotational axis of the first eccentric member; the first swinging sleeve is secured to the body via a first guiding restriction member, limiting rotation of the first swinging sleeve independent of the first eccentric member.

7. The limb massage mechanism according to claim 2, wherein in the width direction of the limb, the second kneading portion and the first shaft are positioned on the same side.

8. The limb massage mechanism according to claim 7, wherein a second conversion component is provided on the first shaft; the second conversion component is configured to convert the rational force of the first shaft into a swinging motion of the second kneading component.

9. The limb massage mechanism according to claim 8, wherein the second kneading device comprises a second swinging arm coupled with the second kneading component; the second conversion component comprises a second eccentric member and a second swinging sleeve; the second swinging sleeve is fitted over the first shaft and is rotated with the first shaft; the second swinging sleeve is fitted over the second eccentric member and connected to the second swinging arm; a swinging axis of the second swinging sleeve coincides with a rotational axis of the second eccentric member; the second swinging sleeve is secured to the body via a second guiding restriction member, limiting rotation of the second swinging sleeve independent of the second eccentric member.

10. The limb massage mechanism according to claim 1, wherein the percussion massage device comprises a percussion shaft, and an eccentric component fitted over the percussion shaft and rotated with the percussion shaft; the swinging sleeve is fitted over the eccentric component; a swinging axis of the swing sleeve coincides with a rotational axis of the eccentric component; the percussion member is secured to the swinging sleeve so that the percussion member is driven by the eccentric component and perform percussive massage.

11. The limb massage mechanism according to claim 10, wherein the second kneading device comprises a third guiding restriction member that allows radial movement of the percussion member along the percussion shaft and restricts the rotation of the percussion member with the percussion shaft.

12. The limb massage mechanism according to claim 10, wherein the percussion massage device is fixedly connected to the second kneading device.

13. The limb massage mechanism according to claim 11, wherein the third guiding restriction member is fixedly connected to the body.

14. The limb massage mechanism according to claim 2, wherein the limb massage mechanism further comprises a second shaft configured for driving the second kneading component and the first kneading component to move towards or away from each other; the second shaft is arranged parallelly to the first shaft.

15. The limb massage mechanism according to claim 14, wherein the second shaft is coupled with a second conversion component; the second conversion component is configured for converting the rotational force of the second shaft into a swinging motion of the second kneading portion.

16. The limb massage mechanism according to claim 15, wherein the second kneading device comprises a second swinging arm attached to the second kneading component; the second conversion component comprises a second eccentric member and a second swinging sleeve; the second eccentric member is fitted over the second shaft and rotates with the second shaft; the second swinging sleeve is fitted over the second eccentric member; a swinging axis of the second swinging sleeve coincides with a rotational axis of the second eccentric member; the second swinging sleeve is connected to the body through the second guiding restriction member, limiting the rotation of the second swinging sleeve independent of the second eccentric member.

17. The limb massage mechanism according to claim 1, wherein the first swinging arm is provided with a first massage airbag configured for squeezing and massaging the limb.

18. The limb massage mechanism according to claim 1, wherein the second kneading component is provided with a second massage airbag configured for squeezing and massaging the limb.

19. A limb massager having both kneading and percussion massage, comprising the limb massage mechanism of claim 1.

20. A massage chair equipped with armrests, wherein the armrest is provided with the limb massage mechanism of claim 1.
